(19) United States
(12) Patent Application Publication
(10) Pub. No.: US 2015/0247267 A1
(43) Pub. Date: Sep. 3, 2015

(54) VARIABLE TRANSPARENCY FABRIC, WINDOW SHADE INCLUDING SAME AND RELATED METHOD

(71) Applicant: Comfortex Window Fashions, Maplewood, NY (US)

(72) Inventor: John A. Corey, Troy, NY (US)

(21) Appl. No.: 14/635,520

(22) Filed: Mar. 2, 2015

Related U.S. Application Data
(60) Provisional application No. 61/947,116, filed on Mar. 3, 2014.

(51) Int. Cl. D03D 19/00; D03D 1/00; D03D 15/00; D03D 15/08; E06B 9/38; E06B 9/68

(52) U.S. Cl. CPC D03D 19/00; E06B 9/38; E06B 9/68; D03D 15/0077; D03D 15/08; D03D 1/0017; D10B 2503/03

(57) ABSTRACT

A fabric for a window shade, a window shade including the fabric and a related method are disclosed. The fabric may include a relaxed condition in which the fabric is translucent or at least partially opaque; and at least one stretched condition caused by application of a tension in a single linear direction, wherein a degree of transparency of the fabric depends on an extent of the tension, The fabric exhibits substantially no dimension change other than in the single linear direction in response to tension. A roller shade for a window may include a roller including a position selectable, retraction system operatively coupled thereto; and the fabric on the roller.

### CROSS-REFERENCE TO RELATED APPLICATIONS

This application claims the benefit of co-pending U.S. provisional patent application No. 61/947,116 filed Mar. 3, 2014, which is hereby incorporated herein.

### BACKGROUND

1. Technical Field

The disclosure relates generally to fabrics, and more particularly, to a variable transparency (and translucency) fabric, a window shade including the fabric and a related method.

2. Background Art

A roller shade, in which a flat, rectangular piece of material (typically fabric or film) is stored in rolled form on a substantially cylindrical roller core at the top edge of a window and unrolled when desired to cover the window to block view or modulate light, is one of the older forms of window shading. Roller shades are inexpensive to manufacture and can utilize a wide range of shade materials. Spring-loaded and ratcheted roller cores are common, eliminating need for any visible actuating means or safety concerns of exposed cords. Corded clutch drives are also popular.

Light modulation by these simple rollers is achieved by partial deployment of the shade material over the window area, and most hardware allows for any portion of the window to be covered or uncovered. However, this is a crude control, and sunlight and view is unimpeded in the uncovered portion leading to glare and privacy loss. Translucent or sheer fabrics, hung for instance as draperies, that still admit diffuse light when fully deployed are one response, but these are often an unsatisfactory compromise between view and privacy.

One often-tried approach to an ideal window treatment is electrochromic glass, which dispenses with a separate window shade and instead provides a coating or film on the glass itself that changes opacity in response to an applied voltage or current. Some forms of this device have quick-switch capability and some have proportional control. These devices are visually effective, but very costly, require electrical connections, and are not suitable for retrofit onto existing windows. Most darken to an aesthetically undesirable black-ish appearance in privacy mode, by blocking or absorbing light, rather than diffusing it during transmission. Still, these devices point toward a desirable function: total control of window clarity across the entire opening.

Different fabrics have been employed as window treatments, but none has been envisioned or applied as a clarity-modulating window treatment. For example, knit fabrics like jersey or tricot, are well known for extensibility (‘stretch’) properties, yet invariably exhibit a loss of transverse dimension and flatness (necking and curling) when extended in one direction. Such stretchable knits also typically include elastomeric fibers (typically polyurethane-based compounds commonly known as ‘spandex’ or ‘elastane’) that have sensitivity to ultraviolet (UV) light that is present in window use. Still, under some conditions of edge constraint, knits can be made to exhibit some variation in clarity under tension, by variation in the inter-fiber apertures. Mats made of heavy reeds, like Japanese tatami, and the Roman-style window shades called ‘woven-woods’ exhibit large, stiff transverse fibers (bound without significant distortion by finer, cross-woven threads) and so would not neck or curl if pulled in the thread-wise direction. That said, no known mats of woven-wood materials are in fact extensible in the stated direction. Typically, these large fibers are indeed very large, and so too heavy for use in most windows.

### BRIEF SUMMARY

A first aspect of the invention provides a fabric for a window shade, the fabric comprising: a relaxed condition in which the fabric is translucent or at least partially opaque; and at least one stretched condition caused by application of a tension to the fabric in a single linear direction, wherein a degree of transparency of the fabric depends on an extent of the tension, wherein the fabric exhibits substantially no dimension change other than in the single linear direction in response to the tension.

A second aspect of the invention provides a roller shade for a window, the roller shade comprising: a roller including a position selectable, retraction system operatively coupled thereto; and a fabric on the roller, the fabric having: a relaxed condition in which the fabric is translucent or at least partially opaque; and at least one stretched condition caused by application of a tension to the fabric in a single linear direction, wherein a degree of transparency of the fabric depends on an extent of the tension, wherein the fabric exhibits substantially no dimension change in a transverse dimension, relative to the single linear direction, in response to the tension.

A third aspect of the invention provides a shade for a window, the shade comprising: a fabric positionable in a relaxed condition in which the fabric is translucent or at least partially opaque, and in at least one stretched condition caused by application of a tension to the fabric in a single linear direction, wherein a degree of transparency of the fabric depends on an extent of the tension, wherein the fabric exhibits substantially no dimension change in a transverse dimension, relative to the single linear direction, in response to the tension.

A fourth aspect of the invention includes a method for controlling transparency in an aperture, the method comprising: mounting a window shade in the aperture, the window shade including a fabric configured to include a relaxed condition in which the fabric is translucent or at least partially opaque, and at least one stretched condition caused by application of a tension to the fabric in a single linear direction; and modulating a tension applied to the fabric in a single linear direction to control a degree of transparency of the fabric that depends on an extent of the tension, wherein the fabric exhibits substantially no dimension change other than in the single linear direction in response to the tension.

The illustrative aspects of the present invention are designed to solve the problems herein described and/or other problems not discussed.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a perspective view of a shade including a fabric according to embodiments of the invention in a relaxed condition.

FIG. 2 shows a perspective view of a shade including a fabric according to embodiments of the invention in a stretched condition.

FIG. 3 shows an example of one type of a conventional fabric weave, suitable for sheer or open mesh fabric.

FIGS. 4A-C show an embodiment of a model fabric weave according to embodiments of the invention.

FIGS. 5A-H show various longitudinal fibers for use in the fabric according to embodiments of the invention.

FIGS. 6A-C shows a series of photographs indicating the varied transparency of a shade and fabric according to embodiments of the invention.

It is noted that the drawings of the various embodiments of the invention are not to scale. The drawings are intended to depict only typical aspects of the disclosure, and therefore should not be considered as limiting the scope of the invention. In the drawings, like numbering represents like elements among the drawings.

### DETAILED DESCRIPTION

As indicated above, the disclosure provides a fabric and window shade made with the fabric. The new fabric provides a plurality of varying transparency modes such as a diffuse daylight with privacy mode, a sheer view-through mode, and an as-clear-as-glass mode (when retracted). The fabric provides similar functions as an electrochromic glass, but at low cost and without any electrical power required. Hence, embodiments of the invention achieve continuous modulating view clarity between diffuse privacy and viewable clarity, but at low cost and without electricity. In addition, the shading product is retrofittable to existing windows.

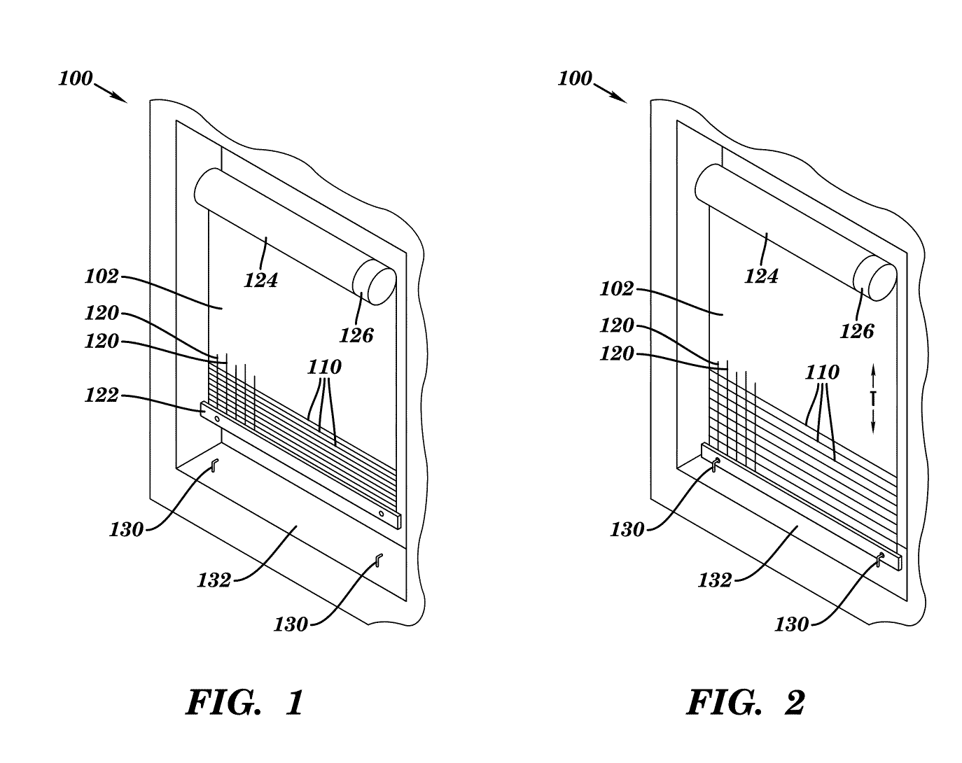

FIGS. 1 and 2 show perspective views of a window shade 100 including a fabric 102 according to embodiments of the invention. As illustrated, window shade 100 includes a roller shade, but as will be described herein, a roller-type embodiment is not necessary in all instances.

Fabric 102 may include a relaxed condition (FIG. 1) in which the fabric is translucent or at least partially opaque. In this setting, the fabric can permit substantially no image or coherent view transmission across the thickness of the fabric. The fabric may also include at least one stretched condition (FIG. 2) caused by application of a tension T (FIG. 2) in a single linear direction. As will be described, a degree of transparency, and in particular, the transmission of a coherent image through the thickness of the fabric depends on an extent of the tension T applied thereto. In order to provide these conditions, fabric 102 may include a plurality of transverse fibers 110 together with a plurality of longitudinal fibers 120. Transverse fibers 110 can run in a direction generally perpendicular to a direction of hanging or deployment of fabric 102 (i.e., a transverse direction), while longitudinal fibers 120 can run in a direction generally parallel to a direction of hanging or deployment of fabric 102 (i.e., a longitudinal direction). The plurality of transverse fibers 110 can be relatively rigid compared to plurality of longitudinal fibers 120, which can be substantially extensible by having the tension T applied thereto in the single linear direction. It is also understood that transverse fibers 110 can be substantially extensible with longitudinal fibers 120 being relatively rigid, as in cases where stretching may be applied transversely.

As indicated in FIG. 2, tension T can be applied along a single linear direction that is substantially parallel with one group of fibers, e.g., longitudinal fibers 120. Tension T may be applied in an upward direction and/or a downward direction as indicated, so long as it is applied generally in a single linear direction substantially perpendicular to the relatively rigid fibers, such as transverse fibers 110 in FIGS. 1 and 2. In this fashion, in a relaxed condition, shown in FIG. 1, longitudinal fibers 120 can act to pull transverse fibers 110 close together, creating small spaces therebetween through which some light may pass but typically not images. In other words, fabric 102 in the relaxed condition can be translucent or at least partially opaque. In contrast, in a stretched condition, as shown in FIG. 2, longitudinal fibers 120 are stretched (e.g., by tension T) to move transverse fibers 110 farther apart, creating larger spaces (i.e., interstitial apertures) therebetween through which more light passes. In the stretched condition, images may be discernible depending on the extent of tension T applied to the fabric. For example, greater amounts of tension T can cause fabric 102 to become more translucent and substantially transparent, permitting transmission of coherent images.

Fabric 102 may be provided in a number of formats. In any case, fabric 102 may include transverse fibers 110 selected and/or oriented to be resistant to transverse dimensional change or curling when under tension T along the single linear direction perpendicular thereto. That is, transverse fibers 110 can be substantially rigid or incompressible fibers arrayed transversely in the fabric, including for example, relatively large sectioned fibers inserted transversely without substantial deformation from interaction with other or crossing longitudinal fibers 120. Transverse fibers 110 may include substantially non-elastomeric polymers. In contrast, longitudinal fibers 120 can be substantially elastic or twisted fibers arrayed lengthwise in the fabric. Longitudinal fibers 120 may include, for example, elastomeric fibers or crimped, coiled, twisted, or textured fibers (either natural, like wool, or synthetic, like polyester or polybutylene terephthalate (PBT)). It is also understood that the composition and function of transverse and longitudinal fibers 110, 120 may be reversed to suit particular applications. Transverse fibers 110 are described herein as being substantially rigid and longitudinal fibers 120 are described as being substantially flexible for the purposes of example.

Transverse and longitudinal fibers 110, 120 are described herein as being “together,” which is meant to indicate engagement in any of a variety of ways such as but not limited to weave, knit, or any of various layered felting methods, etc. In any event, the engagement preferably provides close adjacency of fibers when relaxed, but opens a multiplicity of substantially uniformly spaced small apertures or foramens (also referred to as interstitial apertures) in the textile when under tension T in at least one stretched condition. As understood, fabric 102 is positionable in a number of conditions including, for example, at least: a first stretched condition having a degree of transparency greater than the relaxed condition (larger interstitial apertures allowing more light to pass, but substantially no images); and a second, extensively stretched condition having a degree of transparency that is substantially transparent, e.g., close to or at a point permitting transmission of coherent images. As shown in FIG. 2, due to the rigidity of transverse fibers 110, however, fabric 102 exhibits substantially no dimension change other than in the single linear direction in response to the tension. In other words, fabric 102 in the stretched condition does not bend or warp along the direction parallel to transverse fibers 110. This rigidity in the transverse direction is in contrast to conventional stretchable fabrics.

Window shade 100 of FIGS. 1 and 2 can optionally include other components. For example, longitudinal fibers 120 of fabric 102 can be mechanically coupled to a bottom rail 122 positioned at a bottom end of fabric 102. An upper end of fabric 102 can include a roller 124 and a position selectable retraction system 126 for adjusting the extent to which fabric 102 is deployed. Various embodiments of roller 124 and retraction system 126 are discussed elsewhere herein, and it is understood that alternative embodiments of window shade 100 may not include roller 124 and retraction system 126. One or more fasteners 130 can mechanically couple bottom rail 122 of window shade 100 to a bottom surface of a window 132. In FIGS. 1 and 2, fasteners are shown by example as being L-shaped hook fixtures for engaging corresponding holes within bottom rail 122, but it is understood that other types of instruments can be used as fasteners 130.

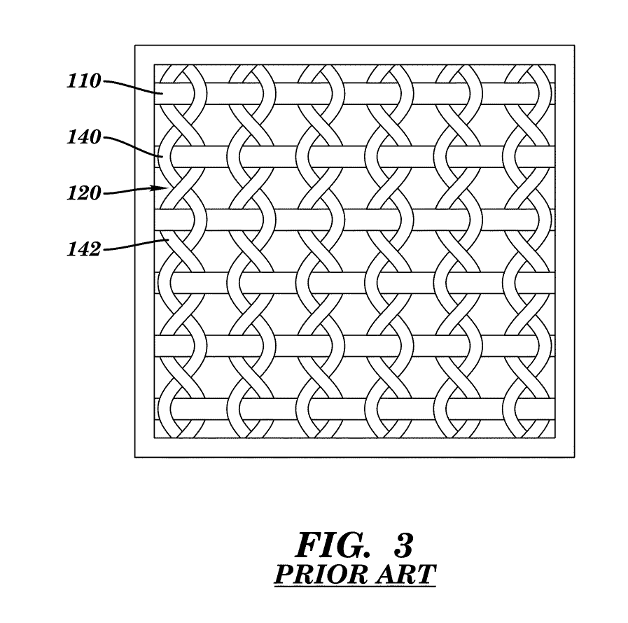

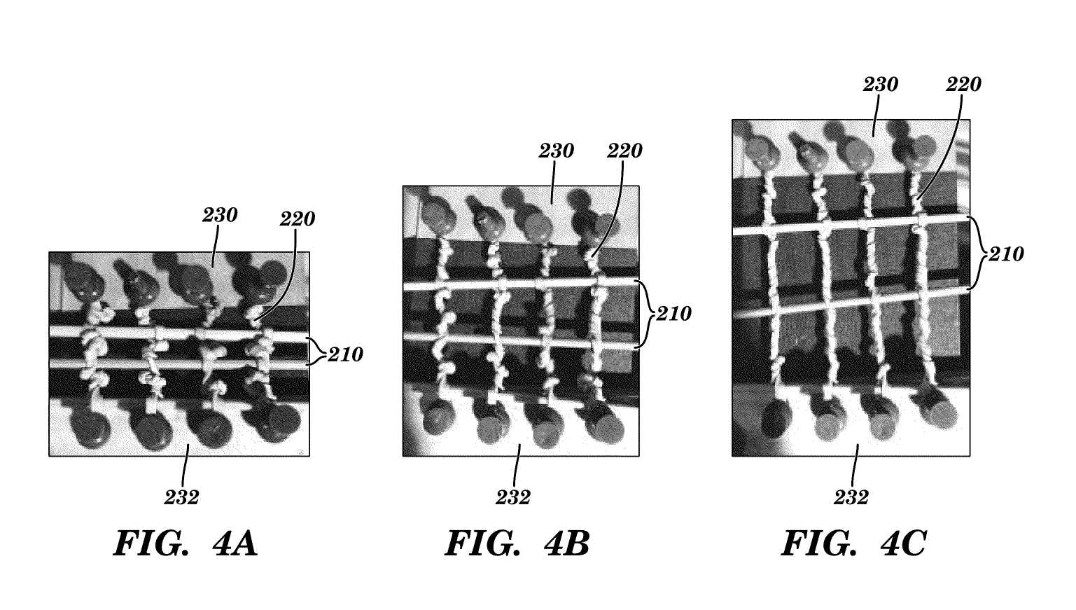

FIGS. 3 and 4A-C show example weaving techniques that can be used to create fabric 102. In FIG. 3, a pair of longitudinal threads 140, 142 that weave about each transverse fiber 110 make up a longitudinal fiber 120. FIG. 3 illustrates a prior art weave called in the trade ‘Leno weave.’ The weave is characterized by paired warp yarns/threads 140, 142 that are twisted together or intertwined in a series of figure eights (alternating left-right twists) with filling, transverse yarn (weft) 110 that is passed through each of the interstices so formed, producing a firm, open mesh. Conventional weaves of this type may use inextensible fibers, and are commonly used for durable mosquito netting. Related variations of this approach include Japanese Karamiori textiles that take such twisted warp pairs into patterns by mixing and matching which threads in which pairs are twisted together. Leno weaves made with elastomers in some threads are also commonly used for waistbands and cuffs in some clothing. However, none of these weaves provide the desired variable clarity effect.

In embodiments of the present invention, the twisted-warp Leno weave may be modified to include further twisting of the warp yarn pairs 140, 142 (longitudinal fibers) between each weft (fill) fiber (transverse fibers 110). The twisted-warp Leno weave in embodiments of the present disclosure can include super-coiling (sometimes called ‘cylindrical snarling’), and may include longitudinal warp yarns (not shown in FIG. 3) with individual texturing or coiling for enhanced extensibility, and may include fill fibers substantially stiffer than the warp yarns 140, 142. Optionally, to ease weaving, ‘ghost’ threads (not shown) may be included in the warp which are not twisted, but serve to regulate the degree of stretch in the twisted, longitudinal fibers during the weaving process. Such ghost threads may be later removed from the finished fabric, which can be done mechanically, thermally, chemically, or by other means known in the trade. The twisting or coiling of warp threads 140, 142 serves to replace or enhance any intrinsic elastomeric property of the yarns; by providing overall extension from the untwisting or coil extension under applied tension. (One example of this effect is familiar to those who used rubber-powered toy airplanes; in which twisting the rubber produced first a simple twist, but then with more twisting induced a coiling of the twisted rubber, and even a ‘double-knot’ secondary coiling if even more twist was applied. In the airplane toys, the length of the twisted rubber is set by the structure locating the propeller attached to one end of the rubber and the other end's fixation to the structure, but it can be easily shown that the coiling can be reversibly undone by separating the propeller mount from the structure to extend the rubber length). This conversion from twist-coiled to just twisted, by tensile extension, is one way to reduce the optical blocking and cross-section of the fiber (or rubber, in the toy airplane analogy), such that a fabric made from such coiled fibers will experience significant changes in size of its interstitial apertures among the fibers when stretched in this way. In any event, fabric 102 is preferably UV-resistant, and can include UV-resistant transverse fibers 110 and longitudinal fibers 120. In addition to the woven compositions discussed herein, embodiments of the present disclosure can also utilize other woven compositions, knit compositions, any of various layered felting methods, etc. All such compositions can exhibit the intended one-dimensional stretch (without narrowing or curling) when configured so the fibers perpendicular to the tension direction are not substantially deformed by the extension of the fibers parallel to the applied tension.

In FIGS. 4A-C, a model of a fabric according to embodiments of the invention is illustrated in a large-scale analog fabric segment formed by fill (weft) of small-diameter, rigid wood dowels as transverse fibers 210 and a warp of twisted rubber bands as longitudinal fibers 220. The upper ends of longitudinal fibers 220 are fastened to a base 230, and the lower ends are attached to a movable bar 232. Longitudinal fibers 220 in this example were each given six full turns of twist, with adjacent bands intended to be in alternating twist directions, between each fill transverse fiber 210 (frame starts and dowel insertions). That is, each longitudinal fiber 220 includes a plurality of twists therein between a corresponding pair of transverse fibers 210. The alternating twists cancel out any bulk twist over the width of the fabric. Although not shown in every instance, twists within each band may also be reversed after each fill insertion to give net zero twist to any one band. When the fill dowels (i.e., transverse fibers 210) are inserted, they lock in the twists (though in a true textile, this twist might be in part set-in, either mechanically or thermally). FIG. 4A shows the relaxed condition, in which the twists have given rise to coiling (cylindrical snarl), thickening the longitudinal fibers 220 and shortening the spacing between transverse fibers 210. The openings (interstitial apertures or foramens) defined by the longitudinal fibers 210 and transverse fibers 220 are minimal and no clear image of the background behind the fabric is visible. In FIGS. 4B and 4C, the lower ends of the longitudinal fibers 220 on movable bar 232 are pulled progressively farther from the top ends attached to base 230. In FIG. 4B, the coils of longitudinal fibers 220 are coming partly out, narrowing shape of longitudinal fibers 220 and extending the spacing between adjacent transverse fibers 210. In FIG. 4C, the extension is sufficient to pull out all the coiling, leaving only a fundamental twist in longitudinal fibers 220, and the spacing between transverse fibers 210 is greater still—enough that there is now a clear and unobstructed visibility to the background behind the fabric. That is, the plurality of twists in longitudinal fibers 210 have a thickness in the relaxed condition and are thinner (i.e., have a reduced thickness) in the at least one stretched condition. However, at no time does the overall width of the fabric change substantially and the edges do not curl out of plane, e.g., due to the composition of transverse fibers 210. It should be appreciated that while the model of FIGS. 4A-C illustrates one version of a preferred embodiment of the invention, the scope of the invention is not limited to the specifics illustrated there. For instance, the coiling and twisting of longitudinal fibers 220 may include different patterns or counts of twists. The fibers (either longitudinal fibers 220 or transverse fibers 210 in the form of a weft fill) can be made of any of a wide range of known materials, including polymers commonly used in window treatments like polyesters or acrylics, and need not be intrinsically elastomeric if the extension is achieved by coiling, twisting, or other form shift (e.g., straightening of zig-zag textured yarns). Also longitudinal fibers 220 need not be mono-filamentary and may include complex twists as is known in ropes and threads. Transverse fibers 210 need not be perfectly rigid, but may include some deflection in engagement with longitudinal fibers 220. Transverse fibers 210 need not span the full width of the fabric, but may be folded or otherwise interlocked with longitudinal fibers 220 over partial spans of fabric 102, as for example in a warp-knit construction.

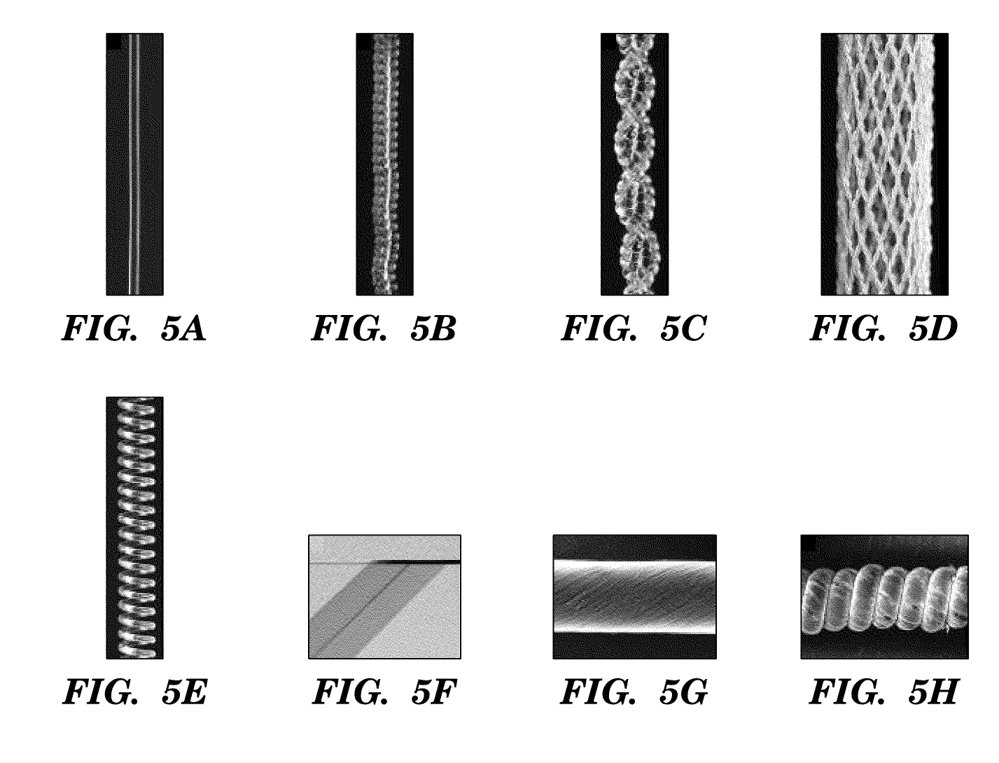

Examples of highly twisted and coiled non-elastomeric fibers that might be suitable for use as extensible warp, longitudinal fibers 120 (FIGS. 1, 2) in embodiments have been published as candidates for artificial muscle in Science 21 Feb. 2014: vol. 343 no. 6173 pp. 868-872 DOI: 10.1126/science.1246906. An image of these fibers, taken from the cited article is shown in FIGS. 5A-H, illustrating some alternate coiling in polymer fibers and combinations of such fibers in braids or plies that may be used in embodiments of the present invention to establish extensibility without elastomers that may degrade in the ultraviolet radiation typical of in-window applications. More particularly, FIGS. 5A-H show various images of a variety of fiber formats that may be employed for longitudinal fibers, including a single, untwisted fiber (FIG. 5A), a textured fiber (twisted to coiling) (FIG. 5B), a coupled helical two thread yarn of twisted, coiled fiber (FIG. 5C), an expandable mesh of yarns like that in C (FIG. 5D), a coiled fiber (FIG. 5E), a marked fiber detail, showing twist of a line originally axial (FIG. 5F), a micrograph of such a twisted fiber F (FIG. 5G), and a micrograph of a coiled twisted fiber (FIG. 5H).

It is emphasized that the view-through quality is not a simple function of open fraction (i.e., the percentage of overall textile face area not actually occupied by fibers). Rather, the view-through quality depends further on the opacity and refractive characteristics of transverse and longitudinal fibers 110, 120 (FIGS. 1, 2), i.e., the ‘openness’ ratio of pore size to textile (or fiber) thickness and (in cases of extremely small pores) to the color of the incident light and the textile itself. One notable product illustrating at least a part of this dependence is the well-known vinyl-coated fiberglass mesh sold variously as ‘Sheerweave’ by Phifer Company, available in openness levels from 1% (with visual transmittance of 4-22%), up to for instance 25% openness, with visual transmittance of 31-32%, depending on textile color. Note that the rated visible transmittance is a measure of light energy at visible frequencies that passes through the product, not the specular (sometimes called regular) transmittance that is more closely associated with the non-diffusive coherent image preservation in transmission (the ‘see-through’ quality) that is modulated in embodiments of the present invention.

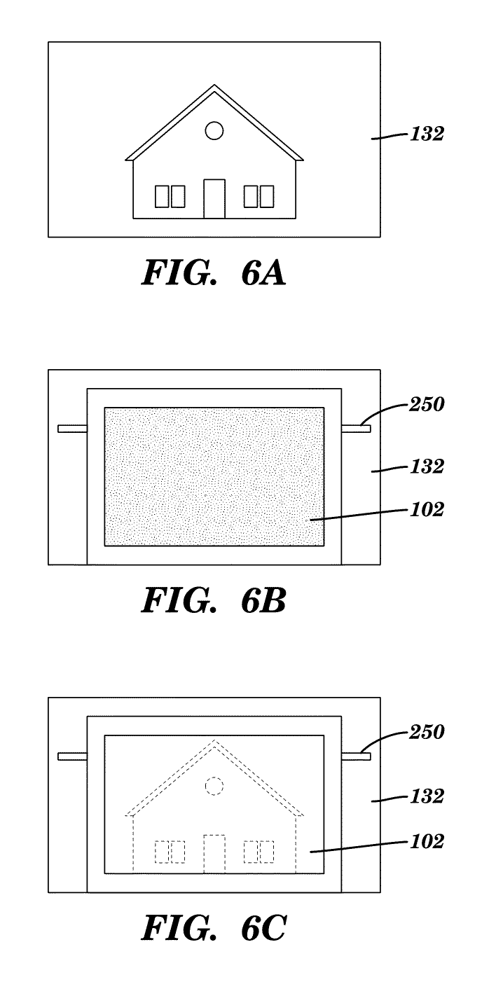

Returning to FIGS. 1 and 2 and with reference to FIGS. 6A-C, various embodiments of window shade 100 operation will now be described. To use fabric 102 in window shade 100, fabric 102 would be cut to size (length and width) as if in a conventional roller shade; but provided with immobilizing attachments, e.g., bottom rail 122 and fasteners 130, for the bottom of the fabric (and the stiffening “bottom rail” customarily provided there). FIG. 1 shows fabric 100 in a relaxed condition. In this example, shade 100 may include bottom rail 122 on a distal end of fabric 102, i.e., from roller 124 thereof. As understood, roller 124 includes a core (not shown) upon which flexible fabric 100 can be selectively rolled. Roller 124 may be part of any conventional headrail. In this fashion, window shade 100 may be mounted in any window or other aperture for use therein. In one embodiment, position-selectable retraction system 126 is provided on or within roller 124. Retraction system 126 may include any now known or later developed control system for roller 124. For example, retraction system 126 may include a clutch system and/or a motorized system. A clutch system may include a cord (as shown) to interact with a clutching mechanism to position roller 124 in a desired position. A motorized system may include a motor to turn roller 124 to a desired position.

As understood, retraction system 126 may be operatively coupled to roller 124 for controlling a vertical position of bottom rail 122 in the relaxed condition. In this fashion, the amount of window 132 obscured by fabric 102 can be controlled. In addition, in accordance with embodiments, fasteners 130 may be provided for attaching bottom rail 122 to window 132 (i.e., a window sill or frame) to allow application of tension T to fabric 102 by retraction system 126. In the example shown, fasteners 130 include a pair of L-shaped hooks fixed to window 132, e.g., by screwing, adhesive, threading into the material of window 132, etc., such that the L-shaped hooks can engage mating holes in bottom rail 122 and substantially prevent bottom rail 122 from moving away from window 132. It is understood that various other mechanisms may be employed within the scope of the invention to attach bottom rail 122 to window 132, and that not all need to engage bottom rail 122 as illustrated.

In operation, retraction system 126 can be used to position fabric 102 in any desired longitudinal position to cover a user-selected amount of window 132. However, when bottom rail 122 is coupled to fastener 130, retraction system 126 can apply tension T to selectively stretch fabric 102. That is, retraction system 126 may be used to modulate a tension applied to fabric 102 in a single linear direction to control a degree of transparency of fabric 102 that depends on an extent of the tension. As noted, fabric 102 exhibits substantially no dimension change other than in the single linear direction in response to the tension. As fabric 102 stretches, however, interstitial apertures between transverse and longitudinal fibers 110, 120 become increasingly larger, changing the transparency and/or translucency of fabric 102. Depending on the weave and materials, fabric 102 may achieve a transparent state in which images are viewable therethrough. FIG. 6A shows an image of a church, viewed through an unobstructed window; FIG. 6B shows the same image with a fabric cover in a relaxed condition in which the image is not viewable but some light passes; and FIG. 6C shows the same image with the fabric in a stretched condition in which the image is substantially viewable through the fabric. The stretch is applied by rotation of a roller-dowel 250 (visible protruding from either side of the frame housing) to which the upper edge of fabric 102 is attached, while the lower edge of fabric 102 is affixed to the lower part of the frame.

Although illustrated and described herein a roller shade, window shade 100 need not take that exact form. For example, fabric 102 may be cut to a desired length that covers a desired amount of the window. Fabric 102 may be fixedly attached at an upper end (e.g., similar to the attachment of longitudinal fabrics 220 to base 230 in FIGS. 4A-4C) and extended to attach a bottom thereof to window 132 in the stretched condition.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A fabric for a window shade, the fabric comprising:
a relaxed condition in which the fabric is translucent or at least partially opaque; and
at least one stretched condition caused by application of a tension to the fabric in a single linear direction, wherein a degree of transparency of the fabric depends on an extent of the tension,
wherein the fabric exhibits substantially no dimension change other than in the single linear direction in response to the tension.

2. The fabric of claim 1, wherein the fabric includes:
a plurality of transverse fibers together with a plurality of longitudinal fibers,
wherein the plurality of transverse fibers are relatively rigid compared to the plurality of longitudinal fibers that are substantially extensible by having the tension applied thereto in the single linear direction.

3. The fabric of claim 2, wherein each longitudinal fiber includes a plurality of twists therein between a corresponding pair of transverse fibers.

4. The fabric of claim 3, wherein at least one of the plurality of twists has a first thickness in the relaxed condition and a second thickness in the at least one stretched condition, the second thickness being less than the first thickness.

5. The fabric of claim 2, wherein the plurality of longitudinal fibers includes substantially non-elastomeric polymers.

6. The fabric of claim 2, wherein at least one of the plurality of longitudinal fibers includes a texture.

7. The fabric of claim 2, wherein at least one of the plurality of longitudinal fibers is twisted.

8. The fabric of claim 2, wherein at least one of the plurality of longitudinal fibers is coiled.

9. The fabric of claim 1, wherein the at least one stretched condition includes at least:
a first stretched condition having a degree of transparency greater than the relaxed condition; and
a second, extensively stretched condition having a degree of transparency that is substantially transparent.

10. The fabric of claim 9, wherein the substantial transparency permits transmission of coherent images through the fabric.

11. A window shade incorporating the fabric of claim 1.

12. A roller shade for a window, the roller shade comprising:
a roller including a position selectable, retraction system operatively coupled thereto; and
a fabric on the roller, the fabric having:
a relaxed condition in which the fabric is translucent or at least partially opaque; and
at least one stretched condition caused by application of a tension to the fabric in a single linear direction, wherein a degree of transparency of the fabric depends on an extent of the tension,
wherein the fabric exhibits substantially no dimension change in a transverse dimension, relative to the single linear direction, in response to the tension.

13. The roller shade of claim 12, wherein the fabric includes:
a plurality of transverse fibers together with a plurality of longitudinal fibers,
wherein the plurality of transverse fibers is resistant to transverse dimensional change or curling of the fabric, relative to a resistance of the plurality of longitudinal fibers to dimensional change or curling of the fabric, the plurality of longitudinal fibers being substantially extensible by having the tension applied thereto in the single linear direction.

14. The roller shade of claim 13, wherein the plurality of longitudinal fibers includes substantially non-elastomeric polymers.

15. The roller shade of claim 13, wherein at least one of the plurality of longitudinal fibers includes a texture.

16. The roller shade of claim 13, wherein at least one of the plurality of longitudinal fibers is twisted.

17. The roller shade of claim 13, wherein at least one of the plurality of longitudinal fibers is coiled.

18. The roller shade of claim 12, wherein the at least one stretched condition includes at least:
a first stretched condition having a degree of transparency greater than the relaxed condition; and
a second, extensively stretched condition having a degree of transparency that is substantially transparent.

19. The roller shade of claim 18, wherein the substantial transparency permits transmission of coherent images.

20. The roller shade of claim 12, further comprising a bottom rail on a distal end of the fabric.

21. The roller shade of claim 20, further comprising a fastener for attaching the bottom rail to a window to allow application of the tension to the fabric by the retraction system.

22. The roller shade of claim 12, wherein the retraction system includes one of a clutch system and a motorized system.

23. The roller shade of claim 12, wherein the fabric is resistant to ultraviolent radiation.

24. A shade for a window, the shade comprising:
a fabric positionable in a relaxed condition in which the fabric is translucent or at least partially opaque, and in at least one stretched condition caused by application of a tension to the fabric in a single linear direction, wherein a degree of transparency of the fabric depends on an extent of the tension,
wherein the fabric exhibits substantially no dimension change in a transverse dimension, relative to the single linear direction, in response to the tension.

25. The shade of claim 24, wherein the fabric includes:
a plurality of transverse fibers together with a plurality of longitudinal fibers,
wherein the plurality of transverse fibers is resistant to transverse dimensional change or curling or curling of the fabric, relative to a resistance of the plurality of longitudinal fibers to dimensional change or curling of the fabric, the plurality of longitudinal fibers being substantially extensible by having the tension applied thereto in the single linear direction.

26. The shade of claim 25, wherein the plurality of longitudinal fibers includes substantially non-elastomeric polymers.

27. The shade of claim 25, wherein at least one of the plurality of longitudinal fibers includes a texture.

28. The shade of claim 25, wherein at least one of the plurality of longitudinal fibers is twisted.

29. The shade of claim 25, wherein at least one of the plurality of longitudinal fibers is coiled.

30. The shade of claim 24, wherein the at least one stretched condition includes at least:
a first stretched condition having a degree of transparency greater than the relaxed condition; and
a second stretched condition that is substantially transparent, permitting transmission of coherent images.

31. The shade of claim 24, further comprising:
a fastener for fastening a transverse edge of the fabric to a window frame; and
a roller upon which the fabric is rolled at an opposing transverse edge, the roller including a retraction system operatively coupled thereto having a plurality of settings corresponding to each stretched condition.

32. The shade of claim 31, wherein the fastener engages a bottom rail coupled to the transverse edge of the fabric.

33. The shade of claim 31, wherein the retraction system includes one of a clutch system and a motorized system.

34. A method for controlling transparency in an aperture, the method comprising:
mounting a window shade in the aperture, the window shade including a fabric configured to include a relaxed condition in which the fabric is translucent or at least partially opaque, and at least one stretched condition caused by application of a tension to the fabric in a single linear direction; and
modulating a tension applied to the fabric in a single linear direction to control a degree of transparency of the fabric that depends on an extent of the tension,
wherein the fabric exhibits substantially no dimension change other than in the single linear direction in response to the tension.

35. The method of claim 34, wherein the fabric includes:
a plurality of transverse fibers together with a plurality of longitudinal fibers,
wherein the plurality of transverse fibers is resistant to transverse dimensional change or curling of the fabric, relative to a resistance of the plurality of longitudinal fibers to dimensional change or curling of the fabric, the plurality of longitudinal fibers being substantially extensible by having the tension applied thereto in the single linear direction.

36. The method of claim 34, wherein the at least one stretched condition includes at least:
a first stretched condition having a degree of transparency greater than the relaxed condition; and
a second, extensively stretched condition having a degree of transparency that is substantially transparent, permitting transmission of a coherent image therethrough.

37. The method of claim 34, further comprising providing the fabric on a roller at one end and anchoring a free end of the fabric, wherein the modulating the tension includes controlling a position of the roller.
